(19) United States
(12) Patent Application Publication
(10) Pub. No.: US 2020/0089650 A1
(43) Pub. Date: Mar. 19, 2020

(54) TECHNIQUES FOR AUTOMATED DATA CLEANSING FOR MACHINE LEARNING ALGORITHMS

(71) Applicant: Software AG, Darmstadt (DE)

(72) Inventors: Swapnil SHARMA, Bangalore (IN); Thanikachalam SUBRAMANIAN, Bangalore (IN); SrinivasaRaju GOTTIMUKKALA, Bangalore (IN)

(21) Appl. No.: 16/131,125

(22) Filed: Sep. 14, 2018

(51) Int. Cl. G06F 15/18; G06F 17/30; G06K 9/62

(52) U.S. Cl. CPC G06F 15/18; G06F 17/30303; G06K 9/6256; G06K 9/6298; G06F 17/30424

(57) ABSTRACT

Machine learning models typically are based on processing large-volume datasets, and datasets are preprocessed so that the machine learning can provide sound results. In building a model, certain example embodiments generate meta-features for each of a number of independent variables in an accessed portion of the dataset. The meta-features are provided as input to pre-trained classification models. Those models output, for the independent variables, indications of one or more appropriate missing value imputation operations, and one or more appropriate other preprocessing data cleansing related operations. The data in the dataset is transformed by selectively applying the missing value imputation operation(s) and the other preprocessing operation(s), in accordance with the independent variables associated with the data, thereby performing the preprocessing in an automated and programmatic way that helps improve the quality of the built model. Ultimately, queries received over a computer-mediated interface can be processed using the built machine learning model.

### TECHNICAL FIELD

Certain example embodiments described herein relate to machine learning systems and/or methods. More particularly, certain example embodiments described herein relate to systems and/or methods that perform improved, automated data cleansing for machine learning algorithms.

### BACKGROUND AND SUMMARY

Machine learning is used in a wide variety of contexts including, for example, facial recognition, automatic search term/phrase completion, song and product recommendations, identification of anomalous behavior in computing systems (e.g., indicative of viruses, malware, hacking, etc.), and so on. Machine learning typically involves building a model from which decisions or determinations can be made. Building a machine learning application and the model that supports it oftentimes involves a significant amount of effort and experience, especially when trying to implement best practices in connection with model building.

FIG. 1 is a flowchart demonstrating how machine learning model building typically takes place. As shown in FIG. 1, model building typically begins with data collection (step S102) in which relevant data is gathered from sources such as, for example, databases, online forms, survey data, sensor data, etc. Data cleansing (step S104) is performed as a collection of preprocessing operations. Preprocessing in this sense refers generally to the transformations applied to data before it is fed into the algorithm or data preprocessing is a technique that is used to convert the raw data into a clean data set. Machine learning models typically are only as good as the data that is used to train them. One characteristic of good training data is that it is provided in a way that is suitable for learning and generalization. The process of putting together the data in this optimal format is known in the industry as feature transformation.

Preprocessing for machine learning models frequently involves missing value imputation, feature normalization, data encoding, and/or other operations to help make sure that the collected data values are according to the requirements of the algorithm. As is known, data imputation refers generally the process of replacing missing data with other (e.g., substituted) values; feature normalization refers generally to a technique used to standardize the range of independent variables or features of data; and data encoding refers generally to operations by which categorical variables are converted into numerical form for consumption by machine learning algorithms and/or similar conversions. Similar to feature normalization, data normalization is known for use in data processing and generally is performed during the data preprocessing step.

Referring once again to FIG. 1, feature engineering (step S106) can involve the derivation of new data from existing data. For example, two columns in a database can be summed, further transformations can be applied to data, etc. Model building (step S108) can involve algorithm selection and parameter (e.g., hyper-parameter) tuning. A model parameter is a configuration variable that is internal to the model and whose value can be estimated from data. Model parameters, generally speaking, are required by the model when making predictions, define the skill of the model on the problem being solved, are estimated or learned from data, often are not set manually, and often are saved as part of the learned model. A model hyper-parameter is a configuration variable that is external to the model and whose value cannot be estimated from data. Model hyper-parameters, generally speaking, are often used in processes to help estimate model parameters, manually specified, sometimes can be set using heuristics, and frequently are tuned for a given predictive modeling problem. It generally is not possible to know the “best” value for a model hyper-parameter on a given problem, although rules of thumb, copy values used on other problems, searching for the best value by trial and error, and/or other similar strategies may be used.

Accuracy checks oftentimes are performed here, and further feature engineering may be performed, e.g., in the event that the accuracy is unacceptable. Once a suitable accuracy has been reached, the model can be deployed in connection with the machine learning application and/or unknown data can be predicted (step S110).

Data collection as referred to in FIG. 1 typically is a highly manual process, and it generally is not considered as an integral part of model building exercise. Typically, the most manually-intensive part of the rest of the process is the data cleansing of step S104. Indeed, data cleansing oftentimes is one of the biggest and most important parts of developing a successful machine learning application. Even with sophisticated model building algorithms, clean and processed data still typically is needed to train the algorithm so that it can learn effectively. The highly manual cleansing and processing operations unfortunately can be challenging in terms of time demands and the needed a prior knowledge and understanding of the data structure.

There are several methods for each of the preprocessing data cleansing operations listed above that can be chosen from and applied to the data. Different approaches are better suited to different kinds of data. As is known, each preprocessing operation can greatly influence the results of the machine learning algorithms, and even the selection of a given type of each of the preprocessing operations can greatly influence the results of the machine learning algorithms.

To help understand problems associated with data cleansing, consider the following example, which involves a dataset about the salaries of different people who have different attributes. In this example, the following table includes data that can be used in model building, e.g., to predict the salary of a new employee.

| Name | Age | Gender | Profession | Experience | Salary |
|---|---|---|---|---|---|
| User 1 | 28 | M | Profession_A | 5 | 50000 |
| User 2 | 26 | M | Profession_B | 1 | 63000 |
| User 3 | 32 | F | Profession_A | 8 | 90000 |
| User 4 | 37 | F | Profession_B | 15 | 76000 |
| User 5 | 33 | M | Profession_C | 10 | 72000 |
| User 6 | 31 | M | Profession_A | NaN | 50000 |
| User 7 | 39 | F | Profession_B | 17 | 60000 |
| User 8 | 32 | M | Profession_A | 9 | 74000 |
| User 9 | 37 | NaN | Profession_A | 11 | 52000 |
| User 10 | 38 | F | Profession_A | 16 | 59000 |

As can be seen from the table above, as one example, the person with name “User 1” gender “Male” of age 28 in profession of “Profession_A” with experience of 5 years earns 50,000. The “NaN” is missing value meaning that information is not available in data. The columns “Name”, “Age”, “Gender”, “Profession”, and “Experience”, are independent variables or features, and the “Salary” column is the target or dependent variable.

As alluded to above, the task is to build a model to help predict the salary of a new employee with certain specified attributes, based on the data in the table above. However, the raw data from the table above cannot be directly passed to a machine learning algorithm. The data needs to be preprocessed, as the machine learning algorithm in this example is designed to accept numerical data and cannot accept missing values or alphanumeric values as input.

Non-numeric data can be processed and then fed to the machine learning algorithms. To treat missing values for a numerical feature (e.g., for a column or independent variable), for example, instances with missing values can be removed; missing values can be replaced with a mean or median value, a value from another instance can be copied, etc. Of course, it can be seen that each of these mentioned approaches for treating missing values can affect the performance of the final model. That is, the approach selected to impute the value directly influences the population of data (the total set of observations that can be made, in statistics terms) and, hence, directly influences the predictive power of the model, which refers to how well the model has learned the pattern in the training data to make predictions on the new data with less error.

In general, for cleaning a column that has information with a class/categorical information (e.g., gender, family type, etc.), one-hot encoding, label encoding, and/or the like, may be used as a data preprocessing approach. As is known, one-hot encoding is a process by which categorical variables are converted into a form that could be provided to machine learning algorithms to do a better job in prediction and generally involves the “binarization” of data. In terms of missing value imputation, a mean, median, some high value, a mode, a random value occurring in the dataset, etc., may be used.

Similarly, in general, for cleaning a column that has information with numerical values (e.g., salary, age, weight, etc.), numerical data preprocessing approaches scaling and/or the like may be used as a data preprocessing approach. Standardization of datasets is a common approach for many machine learning estimators. They might behave badly if the individual features do not more or less look like standard normally distributed data (e.g., a Gaussian distribution with zero mean and unit variance). In this vein, StandardScaler is a method in Python API Sklearn that can be used to standardize features by removing the mean and scaling to unit variance. In terms of missing value imputation, imputation with a frequently occurring class (e.g., in categorical mode), a new “other” class, and/or the like, may be used.

In view of the foregoing, it will be appreciated that data cleansing is widely implemented as a highly manual task. And as people come up with many different ways to perform preprocessing of the data, it oftentimes is highly subjective as well, especially as the structure of data becomes more complicated.

Some approaches work on the basis of identifying the dataset that is most similar to the new dataset, but a high degree of similarity will not always occur. Moreover, even when it can be assumed that the new dataset is most similar to a given reference dataset, applying the same preprocessing techniques to all the columns might not yield the best possible results. For example, a column with name values and a column with gender values would be processed with same preprocessing strategy, which is unlikely to produce good results. Approaches that focus on better accuracy tend to target hyper-parameter tuning more than identifying preprocessing techniques, which will not always produce well-trained models.

It will be appreciated that it would be desirable to overcome the above-identified and/or other problems. For example, it will be appreciated that it would be desirable to improve machine learning algorithms, e.g., by implementing an enhanced preprocessing approach.

One aspect of certain example embodiments relates to overcoming the above-described and/or other issues. For example, one aspect of certain example embodiments relates to improving machine learning algorithms, e.g., by implementing an enhanced preprocessing approach.

Another aspect of certain example embodiments relates to automating the selection of data cleansing preprocessing operations by considering such operations as a classification problem. In machine learning, classification is the problem of identifying to which of a set of categories (sub-populations) a new observation belongs, on the basis of a training set of data containing observations (or instances) whose category membership is known. Examples are assigning a given email to the “spam” or “non-spam” class, and assigning a diagnosis to a given patient based on observed characteristics of the patient (e.g., gender, blood pressure, presence or absence of certain symptoms, etc.). Classification is an example of pattern recognition. In this way, certain example embodiments decide what preprocessing operations are to be taken individually for each column of the data, e.g., by training a classifier model on the descriptive information of the data columns. As will become clearer from the below, the approach of certain example embodiments is different from the state of the art, where data preprocessing for model building is different from the data correction and data quality management process.

In certain example embodiments, a machine learning system is provided. A non-transitory computer readable storage medium stores thereon a dataset having data from which a machine learning model is buildable. An electronic computer-mediated interface is configured to receive a query processable in connection with a machine learning model. Processing resources including at least one hardware processor operably coupled to a memory are configured to execute instructions to perform functionality comprising: accessing at least a portion of the dataset; for each of a plurality of independent variables in the accessed portion of the dataset: generating meta-features for the respective independent variable; providing, as input to at least first and second pre-trained classification models that are different from one another, the generated meta-features for the respective independent variable; receiving, as output from the first pre-trained classification model, an indication of one or more missing value imputation operations appropriate for the respective independent variable; and receiving, as output from the second pre-trained classification model, an indication of one or more other preprocessing data cleansing related operations appropriate for the respective independent variable; transforming the data in the dataset by selectively applying to the data the one or more missing value imputation operations and the one or more other preprocessing data cleansing-related operations, in accordance with the independent variables associated with the data; building the machine learning model based on the transformed data; and enabling queries received over the electronic interface to be processed using the built machine learning model.

According to certain example embodiments, the dataset is a database and the data thereof is stored in a tabular structure of the database, e.g., in which the independent variables correspond to different columns in the database. In some cases, all columns in the database will be treated as independent variables, except for a column including data of a type on which predictions are to be made in response to queries received over the electronic interface.

According to certain example embodiments, the generated meta-features for a given independent variable include basic statistics for the data associated with that independent variable and/or an indication as to whether a seeming numerical variable likely is a categorical variable. With respect to the latter, in some instances and for a given independent variable, the indication as to whether a seeming numerical variable likely is a categorical variable may be based on a determination as to whether a count of the unique data entries thereof divided by the total number of data entries is less than a threshold value.

According to certain example embodiments, the first and/or second pre-trained classification models may be able to generate output indicating that no operations are appropriate for a given independent variable.

According to certain example embodiments, the first and second pre-trained classification models may be generated independently from one another yet may be based on a common set of meta-features generated from at least one training dataset.

According to certain example embodiments, the at least one training dataset may be different from the dataset stored on the non-transitory computer readable storage medium. In some cases, independent variables in the at least one training dataset may have one or more missing value imputation operations and one or more other preprocessing data cleansing-related operations, manually assigned thereto.

In addition to the features of the previous paragraphs, counterpart methods, non-transitory computer readable storage media tangibly storing instructions for performing such methods, executable computer programs, and the like, are contemplated herein, as well.

These features, aspects, advantages, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a flowchart demonstrating how machine learning model building typically takes place;

FIG. 2 is a flowchart summarizing a conventional approach to data preprocessing;

FIG. 3 is a flowchart summarizing an improved approach to data preprocessing in accordance with certain example embodiments;

FIG. 4 is a flowchart providing an overview of model training performed in connection with the data cleansing approach of certain example embodiments;

FIG. 5 is a table showing meta-features created for an example dataset, in accordance with certain example embodiments;

FIG. 6 is an augmented version of FIG. 5, showing example missing value imputation and preprocessing operation assignments, in accordance with certain example embodiments;

FIG. 7 is a flowchart showing the trained algorithms running on data in a dataset in accordance with certain example embodiments;

FIG. 8 is a table showing sample data used to demonstrate the operation of the FIG. 7 approach, in accordance with certain example embodiments;

FIG. 9 is a table showing meta-features created for the FIG. 8 example dataset, in accordance with certain example embodiments; and

FIG. 10 is an augmented version of FIG. 9, showing example missing value imputation and preprocessing operation assignments, in accordance with certain example embodiments.

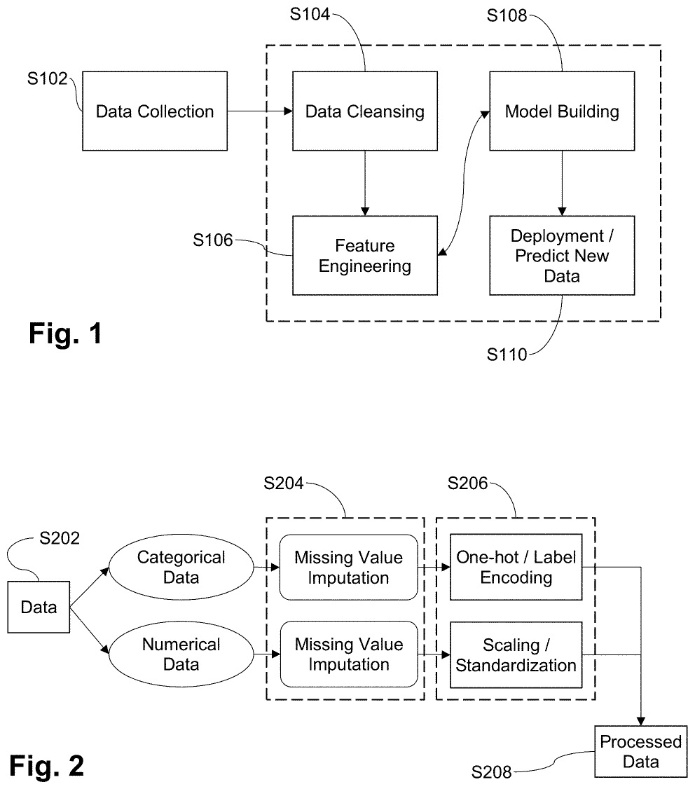

### DETAILED DESCRIPTION

Certain example embodiments described herein relate to systems and/or methods for automating the selection of data cleansing operations for a machine learning algorithm at the preprocessing stage, using a classification approach typically used in more substantive machine learning processing. Certain example embodiments automatically choose the kind of preprocessing operations needed to make the data acceptable to machine learning algorithms. In certain example embodiments, it becomes feasible to predict the data cleansing operations for a particular column or for a complete dataset very quickly, which helps improve performance at the preprocessing phase in an automatic manner that removes subjectivity and does not require reliance on the accuracy values of the model performance.

Certain example embodiments implement powerful classification algorithms and leverage the data prepared manually to train the algorithm. The classification algorithms have already proven their proficiency on learning the pattern within the data. Thus, in some instances, it is reasonable to treat the data prepared for the training as already having the information that a data scientist would use to make the decision of what preprocessing operations need to be taken for the data columns.

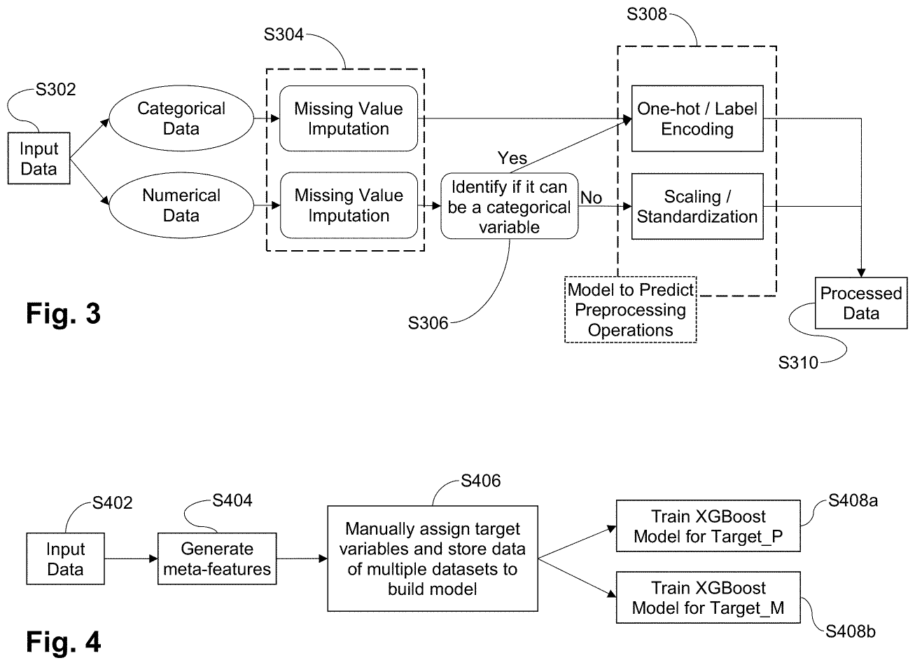

In this regard, FIG. 2 is a flowchart summarizing a conventional approach to data preprocessing, and FIG. 3 is a flowchart summarizing an improved approach to data preprocessing in accordance with certain example embodiments. As shown in FIG. 2, in step S202, the data is read and the data types (e.g., one of categorical and numerical data types) of different records are identified. In step S204, missing values are filled using imputation techniques. In step S206, categorical variables are transformed using one-hot encoding or label encoding, and numerical variables are treated with scaling operations. In step S208, the preprocessed data is ready for consumption by machine learning algorithms.

The FIG. 3 approach is able to achieve better predictions and improve the choice of preprocessing, automatically. As with FIG. 2, the FIG. 3 approach of certain example embodiments involves reading the data and identifying the data types for the different data records in step S302, and filling in missing values via imputation in step S304. However, in step S306, numerical variables are passed through a program (described in greater detail below) to identify whether they can be treated like categorical variables. If so, the variables are flagged and treated as categorical variable. If not, they are treated as numerical variables. In step S308, the decision of which preprocessing operations are to be applied will be predicted by a trained machine learning algorithm. In step S310, the processed data is ready for consumption by the machine learning algorithms.

### Example Implementation

Details concerning an example implementation are provided below. It will be appreciated that this example implementation is provided to help demonstrate concepts of certain example embodiments, and aspects thereof are non-limiting in nature unless specifically claimed. For example, descriptions concerning example code, classifiers, classes, functions, data structures, data sources, etc., are non-limiting in nature unless specifically claimed.

Certain example embodiments involve data cleansing being performed in two independent tasks, namely, missing value imputation and selection of preprocessing steps. FIG. 4 is a flowchart providing an overview of model training performed in connection with the data cleansing approach of certain example embodiments. That is, in step S402, data is received and, to implement this approach, certain example embodiments begin with preparing the dataset of meta-features extracted from different datasets, and storing them in tabular format, as noted in step S404.

To help explain how this may be done, consider once again the example dataset provided in the Background and Summary section, above. To prepare the meta-features of the data, Python's pandas library “describe( )” function was used to generate standard meta-features. Other meta-features were derived as well. The following table provides an overview of the generated and derived meta-features.

| # | Heading | Description | Categorical | Numerical |
|---|---|---|---|---|
| 1 | 25% | 25th percentile of data | X | Y |
| 2 | 50% | 50th percentile of data | X | Y |
| 3 | 75% | 75th percentile of data | X | Y |
| 4 | count | Count of data, rows | Y | Y |
| 5 | dataVal | Type of data given: | Y | Y |
| | | Categorical or Numerical | | |
| 6 | dtypea | Converted data type | Y | Y |
| 7 | max | Maximum of data | X | Y |
| 7 | mean | Mean of the data | X | Y |
| 9 | medMean | Difference of mean and | X | Y |
| | | median of the data | | |
| 10 | median | Median of the data | X | Y |
| 11 | min | Minimum of the data | X | Y |
| 12 | nuniq | Unique count of data | Y | Y |
| 13 | shapiro | Shapiro index for test of | X | Y |
| | | normality | | |
| 14 | std | Standard deviation of the data | X | Y |

The “dtypea” column does not come from Python's inbuilt libraries or functions. Instead, it is logic implemented in certain example embodiments that has been built to handle special cases and to improve the accuracy of the model. It can be considered to be a part of feature engineering in the model-building exercise. This column in essence helps to capture those instances where the data provided is numerical but has its information in accordance with a categorical variable. For example, sometimes a data column like gender will be coded numerically, e.g., with 0 representing “male” and 1 representing “female”. For this particular scenario, by the data type definition, Python will consider it as numerical variable. However, the “dtypea” value will essentially serve as a flag and enable Python to look for this kind of data and provide information indicating that the data is to be treated like a categorical variable instead of a numerical variable (which is its original data type). To derive “dtypea” as in the table above, the following example program logic may be used:

```
If uniqueCount / rowsinData < thresholdValue:
    DatatypeoftheColumn = Categorical
Else:
    DatatypeoftheColumn = Numerical
```

In this example, “thresholdValue” is an empirical value and is calculated as a ratio of the maximum numbers of classes in a column and the number of rows (max number of classes/number of rows).

In the table above, “medMean” is difference between the mean and median values of a column and also does not come from Python's in-built libraries but instead is derived based on this simple mathematical formula. This variable is developed through feature engineering and helps provide information concerning the spread of the data and can be used to help in deciding on an appropriate missing value imputation approach for numerical data columns. Generally, a data scientist can uses this information to decide which value should be used to fill missing values via imputation, e.g., depending on the difference of the values.

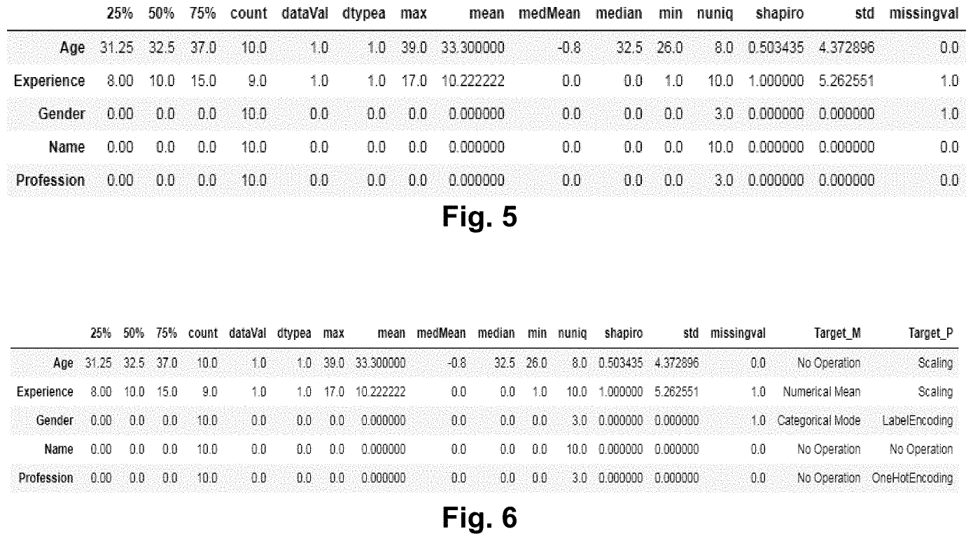

To prepare the meta-features of the dataset above, the example code set forth in the Code Appendix may be used. The sample of the training dataset, following step S404 in FIG. 4 and following execution of the code in the Code Appendix, may be as presented in FIG. 5. That is, FIG. 5 is a table showing the meta-features created for the example dataset, in accordance with certain example embodiments. As shown in FIG. 5, the 25%, 50%, 75%, count, dataVal, dtypea, max, mean, medMean, median, min, missingval, nuniq, shapiro, and std columns are the independent variable. The meta-features of the target variable (here, Salary) are not generated or derived, as the target variable does not need to be processed in this way.

Referring once again to FIG. 4, “Target_P” refers to the type of preprocessing operation(s) to be implemented, and “Target_M” refers to the missing value imputation operation(s) to be implemented. The “Target_M” (missing value imputation operation) and “Target_P” (preprocessing operations) values are manually assigned for the independent variables as indicated in step S406 (and potentially for other known columns) in this training exercise. Similar training data is manually prepared for different datasets, which will be subjected to an XGBoost (or other) classification algorithm to build the models. As is known, XGBoost is an open-source software library that provides a gradient boosting framework and is compatible with a variety of programming languages, including Python.

FIG. 6 is an augmented version of FIG. 5, showing example missing value imputation and preprocessing operation assignments, in accordance with certain example embodiments. In FIG. 6, each row describes a meta-feature of a column from the dataset. The XGBoost algorithm's task would be to learn the pattern of meta-features for Target_M and Target_P. This is the training referred to in steps S408a-S408b in FIG. 4. As described above, missing value imputation and preprocessing operations are considered to be independent tasks. Thus, two different XGBoost classifier models are built, with one helping to identify which missing value imputation operations are to be performed on the various independent variables, and the other to identify which other data cleansing related preprocessing operations are to be performed on the various independent variables. It will be appreciated that the number of operations that can be used for missing value imputation and data preprocessing have been restricted for the ease of implementation and illustration in this example, but different example embodiments can use additional and/or alternative methods for either or both of the respective operations. Similarly, it will be appreciated that only two classification models are provided to provide as output an indication as to which missing value imputation and other preprocessing operations are to be performed for the various independent variables, but different example embodiments may generate a more fine-grained indication of which preprocessing operations should be used, i.e., such that there are two, three, four, or possibly even more classifiers used with respective operations identified for each category. The trained algorithms are able to classify the preprocessing and missing value imputation operations as output, given the meta-features for new datasets as an input.

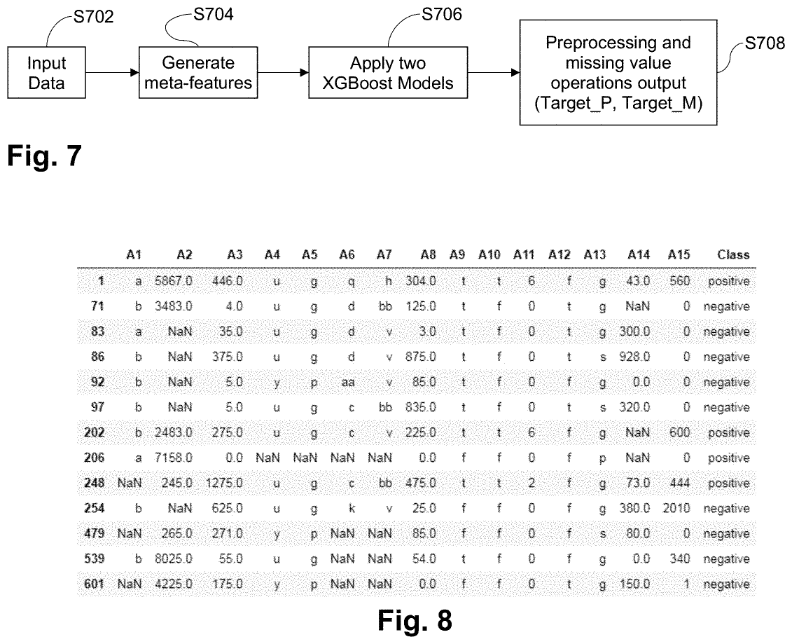

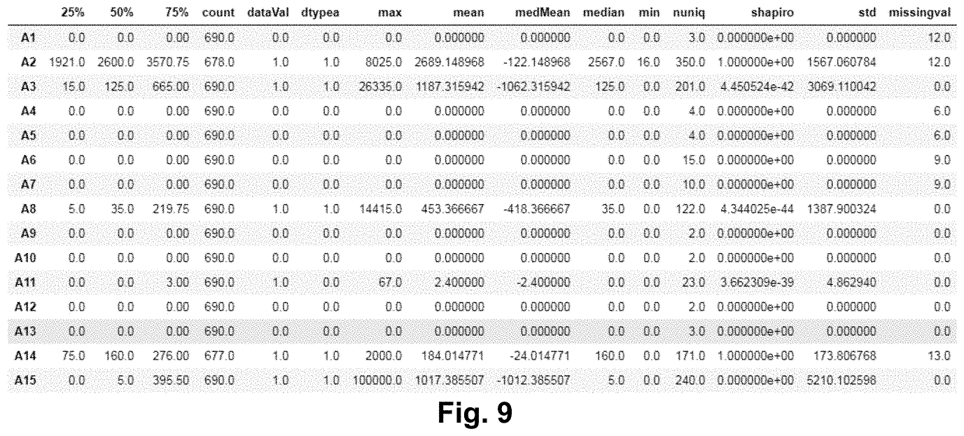

The application of the trained models to predict the preprocessing and missing value imputation operations (“Target_M” and “Target_P”) to be applied to independent variables in a dataset will now be demonstrated. In this regard, FIG. 7 is a flowchart showing the trained algorithms running on data in a dataset in accordance with certain example embodiments. In step S702, the data is loaded. In this example, data concerning credit card applications from the dataset available at https://www.openml.org/d/29 is used. In this dataset, attribute names and values have been changed to meaningless symbols to protect the confidentiality of the data. Sample data from the dataset looks like that shown in the FIG. 8 table. The data column names are anonymized, which has been found to happen (or “effectively” happen) in most of machine learning model building exercises where a person tasked with creating the model does not know much about the data's descriptive nature. As above, “NaN” represents a missing value, and the dataset has mixed data types (in this case, both categorical and numerical columns). The “Class” column is the target variable for which the model needs to be build. In the “Class” column, a “positive” value indicates that a credit card application can be approved, whereas a “negative” value indicates that the application is to be rejected.

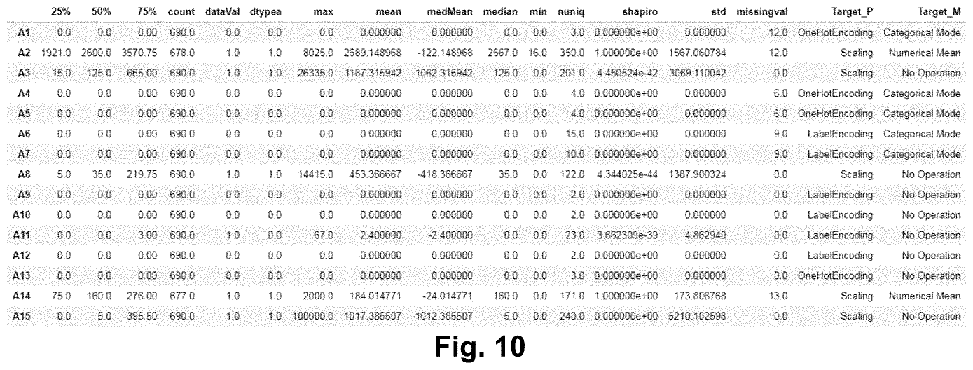

In step S704, meta-features of the data are extracted. This leads to the table shown in FIG. 9. As reflected in step S706 and S708 of FIG. 7, the meta-features are passed through the trained XGBoost models to predict the “Target_M” and “Target_P” operations, i.e., the missing value imputation and preprocessing operations to be applied to each column. FIG. 10 shows the output in the form of an augmented version of FIG. 9.

In FIG. 10, it will be appreciated that the “Scaling” value in “Target_P” column is a proxy for a standard or other scaling process, and can be replaced by other scaling techniques. Also, “Categorical Mode” is a missing value imputation approach that in this example fills the missing values with most commonly occurring value in the categorical columns. It will be appreciated that the approach described herein can be provided with additional types of preprocessing operations, e.g., which may improve the accuracy of the model and be more effective with additional training data.

As will be appreciated from FIG. 10, column A11 in the original dataset is a numerical column but has been considered a categorical variable with the help of the “dtypea” column. The dtypea value helps in assessing it as including categorical values and, hence, the model was able to predict the preprocessing steps for a categorical column. The variable corresponding to column A11 could have been treated as being numerical, as it is in numerical format already. The label encoding also creates a sequence of numbers, indicating that the difference in treatment as between a numerical and categorical variable here would not be so great if the dataset has a comparatively small size (e.g., up to 600 rows or so), but here there would be a difference expected because of the significant size of the dataset (e.g., more than 10,000 records). This new information on column A11 would be taken into account in model training and in assessing new searches against the model and an in at least some instances result in a significant jump in the model's accuracy.

The output from the algorithm is correct with respect to how the models have been trained. This approach as a whole advantageously helps on to automate the data cleansing process in a faster, less subjective, more predictable way. Moreover, certain example embodiments advantageously can be extended to predict and implement additional types of preprocessing and/or data imputation approaches, e.g., to help increase the effectiveness of the approach as needed and/or desired. Once the data cleansing approaches are determined, they can be used on the data in the datasets as appropriate. Finally, the models can be reliably trained and reliably used for future machine learning applications.

Although certain example embodiments are described as having data coming from a database with a table structure and with database columns providing variables, it will be appreciated that other example embodiments may retrieve data and/or process data from other sources. XML, JSON, and/or other stores of information may serve as data sources in certain example embodiments. In these and/or other structures, independent and/or dependent variables may be explicitly or implicitly defined by labels, tags, and/or the like.

It will be appreciated that the machine learning system described herein may be implemented in a computing system (e.g., a distributed computing system) comprising processing resources including at least one hardware processor and a memory operably coupled thereto, and a non-transitory computer readable storage medium tangibly storing the dataset(s), pre-trained classification models, etc. The non-transitory computer readable storage medium may store the finally built machine learning model, and that finally built machine learning model may be consulted to respond to queries received over an electronic, computer-mediated interface (e.g., an API, web service call, and/or the like). The queries may originate from remote computing devices (including their own respective processing resources) and applications residing thereon and/or accessible therethrough. Those applications may be used in connection with any suitable machine learning context, including the example contexts discussed above. The processing resources of the machine learning system may be responsible for generation of the pre-trained classification models, execution of code for meta-feature generation, generation of the finally built machine learning model, etc.

In this regard, it will be appreciated that as used herein, the terms system, subsystem, service, engine, module, programmed logic circuitry, and the like may be implemented as any suitable combination of software, hardware, firmware, and/or the like. It also will be appreciated that the storage locations, stores, and repositories discussed herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

### CODE APPENDIX

The following is example code in the Python language that can be used to generate the meta-features of the data in certain example embodiments. It will be appreciated that other programming languages and/or approaches may be used in different example embodiments and that this example code is provided by way of example and without limitation, unless explicitly claimed.

#importing supporting libraries
import pandas as pd
import numpy as np
#reading data
data = pd.read_csv(filepath)
desc=data.describe( )
shapiro={ }
nuniq={ }
median={ }
dtypea={ }
dataVal={ }
medMean={ }
#examining each column and calculating values to generate meta-
#features of particular columns
#Below operation is for Numerical Variables
for k in desc.columns:

| | |
|---|---|
| if desc[k] [‘count’]<1000: | # if # rows in data is less than 10000 |
| thresholdToCheck=.04 | # if above condition met, value is |
| | # kept at .04, the value comes from |
| | # experimenting with lots of data |
| else: | |

thresholdToCheck=.001 # if # rows exceeds 10000, then .001

| | |
|---|---|
| 11=stats.shapiro(data[k])[1] | #Calculating Shapiro index for |
| | #test of normality |

```
    shapiro[k]=11
    nuniq[k]=len(pd.unique(data[k])) #unique number values in a col
    median[k]=np.median(data[k].fillna(0)) #median of the column
    medMean[k]=median[k]-desc[k][‘mean’] #mean of the column
    dataVal[k]=1 #1 means it's a numerical col
    if (nuniq[k]/desc[k][‘count’])<thresholdToCheck:
      dtypea[k]=0  # 0 means the value can be deemed categorical
    else:
      dtypea[k]=1
    print (11,nuniq[k]/desc[k][‘count’])
sha=pd.DataFrame({‘shapiro’:shapiro,‘nuniq’:nuniq,‘median’:median,
‘dtypea’:dtypea,‘medMean’:medMean,‘dataVal’:dataVal}).transpose( )
desc=pd.concat([desc,sha])
#Below operation is for categorical Variables
cat_col=list(set(data.columns)-set(desc.columns))
catDetails={ }
for j in cat_col:
    catDetails[j]={ }
    catDetails[j][‘count’]=len(data[j])
    catDetails[j][‘dtypea’]=0
    catDetails[j][‘nuniq’]=len(pd.unique(data[j]))
catDe=pd.DataFrame(catDetails)
final_data=pd.concat([desc,catDe],axis=1).fillna(0)
missin=pd.DataFrame(pd.isnull(data).sum( ))
missin.columns=[‘missingval’]
missin=missin.transpose( )
final_data=pd.concat([final_data,missin])
final_data=final_data.transpose( )
#Assignment of target variables happens manually.
```

What is claimed is:

1. A machine learning system, comprising:
a non-transitory computer readable storage medium storing thereon a dataset having data from which a machine learning model is buildable;
an electronic computer-mediated interface configured to receive a query processable in connection with a machine learning model;
processing resources including at least one hardware processor operably coupled to a memory, the processing resources being configured to execute instructions to perform functionality comprising:
accessing at least a portion of the dataset;
for each of a plurality of independent variables in the accessed portion of the dataset:
generating meta-features for the respective independent variable;
providing, as input to at least first and second pre-trained classification models that are different from one another, the generated meta-features for the respective independent variable;
receiving, as output from the first pre-trained classification model, an indication of one or more missing value imputation operations appropriate for the respective independent variable; and
receiving, as output from the second pre-trained classification model, an indication of one or more other preprocessing data cleansing related operations appropriate for the respective independent variable;
transforming the data in the dataset by selectively applying to the data the one or more missing value imputation operations and the one or more other preprocessing data cleansing-related operations, in accordance with the independent variables associated with the data;
building the machine learning model based on the transformed data; and
enabling queries received over the electronic interface to be processed using the built machine learning model.

2. The system of claim 1, wherein the dataset is a database and the data thereof is stored in a tabular structure of the database.

3. The system of claim 2, wherein the independent variables correspond to different columns in the database.

4. The system of claim 3, wherein all columns in the database are treated as independent variables, except for a column including data of a type on which predictions are to be made in response to queries received over the electronic interface.

5. The system of claim 1, wherein the generated meta-features for a given independent variable include basic statistics for the data associated with that independent variable.

6. The system of claim 1, wherein the generated meta-features for a given independent variable include an indication as to whether a seeming numerical variable likely is a categorical variable.

7. The system of claim 6, wherein, for a given independent variable, the indication as to whether a seeming numerical variable likely is a categorical variable is based on a determination as to whether a count of the unique data entries thereof divided by the total number of data entries is less than a threshold value.

8. The system of claim 1, wherein the first and/or second pre-trained classification models is/are able to generate output indicating that no operations are appropriate for a given independent variable.

9. The system of claim 1, wherein the first and second pre-trained classification models are generated independently from one another but are based on a common set of meta-features generated from at least one training dataset.

10. The system of claim 9, wherein the at least one training dataset is different from the dataset stored on the non-transitory computer readable storage medium.

11. The system of claim 9, wherein independent variables in the at least one training dataset have one or more missing value imputation operations and one or more other preprocessing data cleansing-related operations, manually assigned thereto.

12. A method of configuring a machine learning system, the method comprising:
accessing at least a portion of a dataset having data from which a machine learning model is buildable;
for each of a plurality of independent variables in the accessed portion of the dataset, and using at least one processor:
generating meta-features for the respective independent variable;
providing, as input to at least first and second pre-trained classification models that are different from one another, the generated meta-features for the respective independent variable;
receiving, as output from the first pre-trained classification model, an indication of one or more missing value imputation operations appropriate for the respective independent variable; and
receiving, as output from the second pre-trained classification model, an indication of one or more other preprocessing data cleansing related operations appropriate for the respective independent variable;
transforming the data in the dataset by selectively applying to the data the one or more missing value imputation operations and the one or more other preprocessing data cleansing-related operations, in accordance with the independent variables associated with the data;
building the machine learning model based on the transformed data; and
enabling queries received over a computer-mediated interface to be processed using the built machine learning model.

13. The method of claim 12, wherein the dataset is a database and the data thereof is stored in a tabular structure of the database, and wherein the independent variables correspond to different columns in the database.

14. The method of claim 12, wherein the generated meta-features for a given independent variable include (a) basic statistics computed for the data associated with that independent variable, and (b) an indication as to whether a seeming numerical variable likely is a categorical variable.

15. The method of claim 14, wherein, for a given independent variable, the indication as to whether a seeming numerical variable likely is a categorical variable is based on a determination as to whether a count of the unique data entries thereof divided by the total number of data entries is less than a threshold value.

16. The method of claim 12, wherein the first and second pre-trained classification models are generated independently from one another but are based on a common set of meta-features generated from at least one training dataset.

17. The method of claim 16, wherein independent variables in the at least one training dataset have one or more missing value imputation operations and one or more other preprocessing data cleansing-related operations, manually assigned thereto.

18. A non-transitory computer-readable storage medium tangibly storing a program, when executed by a processor of a computing system, performs instructions comprising:
accessing at least a portion of a dataset having data from which a machine learning model is buildable;
for each of a plurality of independent variables in the accessed portion of the dataset, and using at least one processor:
generating meta-features for the respective independent variable;
providing, as input to at least first and second pre-trained classification models that are different from one another, the generated meta-features for the respective independent variable;
receiving, as output from the first pre-trained classification model, an indication of one or more missing value imputation operations appropriate for the respective independent variable; and
receiving, as output from the second pre-trained classification model, an indication of one or more other preprocessing data cleansing related operations appropriate for the respective independent variable;
transforming the data in the dataset by selectively applying to the data the one or more missing value imputation operations and the one or more other preprocessing data cleansing-related operations, in accordance with the independent variables associated with the data;
building the machine learning model based on the transformed data; and
enabling queries received over a computer-mediated interface to be processed using the built machine learning model.

19. The non-transitory computer-readable storage medium of claim 18, wherein the generated meta-features for a given independent variable include (a) basic statistics computed for the data associated with that independent variable, and (b) an indication as to whether a seeming numerical variable likely is a categorical variable.

20. The non-transitory computer-readable storage medium of claim 18, wherein the first and second pre-trained classification models are generated independently from one another but are based on a common set of meta-features generated from at least one training dataset.

21. The non-transitory computer-readable storage medium of claim 20, wherein independent variables in the at least one training dataset have one or more missing value imputation operations and one or more other preprocessing data cleansing-related operations, manually assigned thereto.

22. The non-transitory computer-readable storage medium of claim 21, wherein missing value imputation operations are performed on the at least one training dataset prior to generation of the common set of meta-features.
